(19) United States
(12) Patent Application Publication
(10) Pub. No.: US 2020/0227709 A1
(43) Pub. Date: Jul. 16, 2020

(54) LITHIUM ION CELL PIERCE DEGASSING

(71) Applicant: CPS Technology Holdings LLC, New York, NY (US)

(72) Inventors: Dennis L. Dittel, Wyoming, MI (US); Eugene Tritenichenko, Holland, MI (US)

(21) Appl. No.: 16/628,894

(22) PCT Filed: Jul. 6, 2018
(86) PCT No.: PCT/US2018/041130

§ 371 Date: Jan. 6, 2020

Related U.S. Application Data
(60) Provisional application No. 62/529,809, filed on Jul. 7, 2017.

(51) Int. Cl. H01M 2/12; H01M 10/0525; H01M 2/02

(52) U.S. Cl. CPC H01M 2/1241; H01M 2220/20; H01M 2/0262; H01M 10/0525

(57) ABSTRACT

A battery cell (40) includes a battery cell casing (52) enclosing an electrochemical cell (64) and having an opening (53). A patch (60) is secured over the opening (53) in the battery cell casing (52) and has a corresponding aperture (72), and an auxiliary patch (90) is secured over the patch (60) to seal the opening (53) and the aperture (72) in the patch (60).

### CROSS REFERENCE TO RELATED APPLICATIONS

This application claims priority from and the benefit of U.S. Provisional Application Ser. No. 62/529,809, entitled “LITHIUM ION CELL PIERCE DEGASSING,” filed Jul. 7, 2017, and which is hereby incorporated by reference in its entirety for all purposes.

### BACKGROUND

The present disclosure relates generally to the field of batteries and battery modules. More specifically, the present disclosure relates to a method for degassing batteries, and in particular, a method for degassing lithium-ion (Li-ion) batteries.

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

A vehicle that uses one or more battery systems for providing all or a portion of the motive power for the vehicle can be referred to as an xEV, where the term “xEV” is defined herein to include all of the following vehicles, or any variations or combinations thereof, that use electric power for all or a portion of their vehicular motive force. For example, xEVs include electric vehicles (EVs) that utilize electric power for all motive force. As will be appreciated by those skilled in the art, hybrid electric vehicles (HEVs), also considered xEVs, combine an internal combustion engine propulsion system and a battery-powered electric propulsion system, such as 48 Volt (V) or 130V systems. The term HEV may include any variation of a hybrid electric vehicle. For example, full hybrid systems (FHEVs) may provide motive and other electrical power to the vehicle using one or more electric motors, using only an internal combustion engine, or using both. In contrast, mild hybrid systems (MHEVs) disable the internal combustion engine when the vehicle is idling and utilize a battery system to continue powering the air conditioning unit, radio, or other electronics, as well as to restart the engine when propulsion is desired. The mild hybrid system may also apply some level of power assist, during acceleration for example, to supplement the internal combustion engine. Mild hybrids are typically 96V to 130V and recover braking energy through a belt or crank integrated starter generator. Further, a micro-hybrid electric vehicle (mHEV) also uses a “Stop-Start” system similar to the mild hybrids, but the micro-hybrid systems of a mHEV may or may not supply power assist to the internal combustion engine and operates at a voltage below 60V. For the purposes of the present discussion, it should be noted that mHEVs typically do not technically use electric power provided directly to the crankshaft or transmission for any portion of the motive force of the vehicle, but an mHEV may still be considered as an xEV since it does use electric power to supplement a vehicle's power needs when the vehicle is idling with internal combustion engine disabled and recovers braking energy through an integrated starter generator. In addition, a plug-in electric vehicle (PEV) is any vehicle that can be charged from an external source of electricity, such as wall sockets, and the energy stored in the rechargeable battery packs drives or contributes to drive the wheels. PEVs are a subcategory of EVs that include all-electric or battery electric vehicles (BEVs), plug-in hybrid electric vehicles (PHEVs), and electric vehicle conversions of hybrid electric vehicles and conventional internal combustion engine vehicles.

xEVs as described above may provide a number of advantages as compared to more traditional gas-powered vehicles using only internal combustion engines and traditional electrical systems, which are typically 12V systems powered by a lead acid battery. For example, xEVs may produce fewer undesirable emission products and may exhibit greater fuel efficiency as compared to traditional internal combustion vehicles and, in some cases, such xEVs may eliminate the use of gasoline entirely, as is the case of certain types of EVs or PEVs.

As technology continues to evolve, there is a need to provide improved power sources, particularly battery modules, for such vehicles. For example, gas generation in Li-ion based batteries may occur both during normal cell operation at room temperature and, more especially, at elevated temperatures. The consequence of gas build up may include expansion of the battery cell and potential rupture of the battery, leading to battery failure or the triggering of low pressure safety features.

Methods have been devised to degas batteries to reduce the risk of pressure build up in the battery or battery failure. However, such methods typically include using a temporary plug to release the gas from the battery or simple tape to seal the aperture created for the gas to escape. In either situation, there is an increased risk of contaminants entering the cell from either the sealing material itself or the degassing process taking an extended period of time to complete, thereby reducing manufacturing throughput.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure relates to a method of manufacturing a battery cell. The method includes, among other things, introducing an electrolyte into a casing of the battery cell via an opening in the casing. The method includes sealing the opening, piercing the sealed opening to create an aperture through which gas escapes, and sealing the aperture.

The present disclosure also relates to a battery cell including a battery cell casing enclosing an electrochemical cell and having an opening. The battery cell also includes a patch secured over the opening in the battery cell casing and having a corresponding aperture, and an auxiliary patch secured over the patch to seal the opening and the aperture in the patch.

The present disclosure further relates to a lithium ion battery cell produced by a process that includes introducing an electrolyte into a casing of the battery cell via an opening in the casing. The method also includes sealing the opening and piercing the sealed opening to create an aperture through which gas escapes. The method further includes sealing the aperture.

### DRAWINGS

Various aspects of this disclosure may be better understood upon reading the following detailed description and upon reference to the drawings in which:

FIG. 1 is a perspective view of a vehicle having a battery system configured in accordance with present embodiments to provide power for various components of the vehicle, in accordance with an aspect of the present disclosure;

FIG. 2 is a cutaway schematic view of an embodiment of the vehicle and the battery system of FIG. 1, in accordance with an aspect of the present disclosure;

FIG. 3 is a perspective view of an embodiment of the battery system of FIG. 1, in accordance with an aspect of the present disclosure;

FIG. 4 is a perspective view of an embodiment of a battery cell having an opening being sealed with a patch, in accordance with an aspect of the present disclosure;

FIG. 5 is a perspective view of the battery cell of FIG. 4 after the patch has sealed the opening, in accordance with an aspect of the present disclosure;

FIG. 6 is a perspective view of the battery cell of FIG. 5 after a piercing tool has pierced the patch to allow degassing of the battery cell, in accordance with an aspect of the present disclosure;

FIG. 7 is a perspective view of the battery cell of FIG. 6 being sealed using an auxiliary patch, in accordance with an aspect of the present disclosure; and

FIG. 8 is a process flow diagram of an embodiment of manufacturing a battery cell in which the battery cell is pierced to allow the battery cell to be degassed, in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As set forth above, during production of certain battery cells (e.g., lithium ion battery cells), such cells may experience a buildup of pressure. Methods have been devised to degas batteries to reduce the risk of pressure build up in the battery or battery failure. However, such methods typically include using a temporary plug to release the gas from the battery or simple tape to seal the aperture created for the gas to escape. In either situation, there is an increased risk of contaminants entering the cell from either the sealing material itself or the degassing process taking an extended period of time to complete, thereby reducing manufacturing throughput.

The present disclosure may address these and other shortcomings of traditional degassing approaches by, in certain embodiments, providing a patch that seals the battery cell during formation. The battery cell may then be pierced to allow for degassing and associated pressure relief using a piercing tool, such as a needle. The battery cell is then re-sealed, allowing the battery cell to be finished in a manner that does not leave the cell at a state of elevated internal pressure. Such degassing may be performed relatively rapidly, as the needle or other tool used for piercing may also allow a concomitant release of gas once the cell is pierced. For example, the process of piercing the cell to allow the release of gases may be completed in 10 seconds or less, or 8 seconds or less, such as between 2 seconds and 8 seconds.

The battery systems described herein may be used to provide power to various types of electric vehicles (xEVs) and other high voltage energy storage/expending applications (e.g., electrical grid power storage systems). Such battery systems may include one or more battery modules, each battery module having a number of battery cells (e.g., lithium-ion (Li-ion) electrochemical cells) arranged and electrically interconnected to provide particular voltages and/or currents useful to power, for example, one or more components of an xEV. As another example, battery modules in accordance with present embodiments may be incorporated with or provide power to stationary power systems (e.g., non-automotive systems).

To simplify the following discussion, the present techniques will be described in relation to a battery system with a 12 volt lithium ion battery and a 12 volt lead-acid battery. However, one of ordinary skill in art is able to adapt the present techniques to other battery systems, such as a battery system with a 48 volt lithium ion battery and a 12 volt lead-acid battery, systems that utilize high voltage (HV) lithium ion battery systems, stationary energy storage systems, and the like.

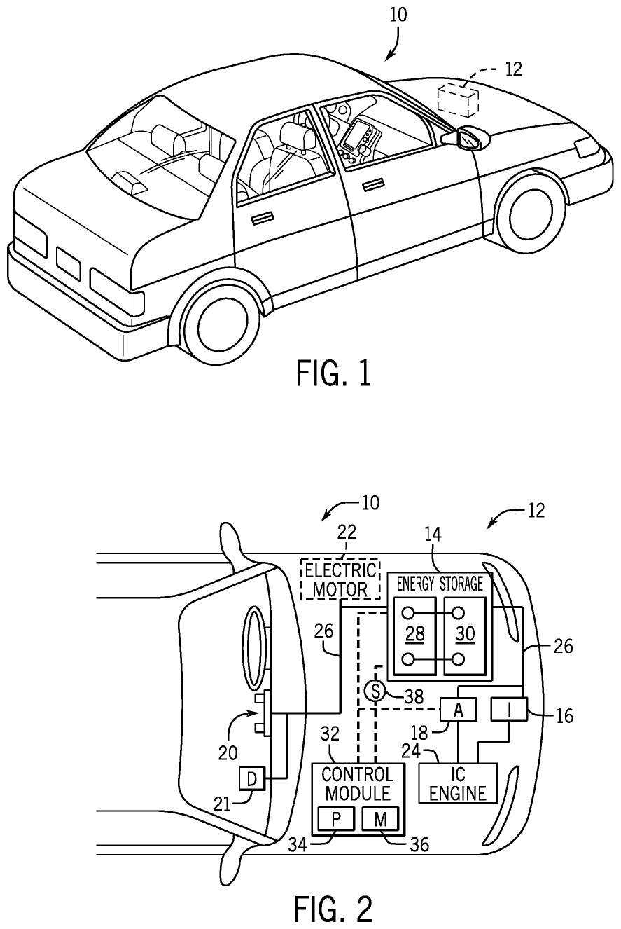

To help illustrate, FIG. 1 is a perspective view of an embodiment of a vehicle 10, which may utilize a regenerative braking system. Although the following discussion is presented in relation to vehicles with regenerative braking systems, the techniques described herein are adaptable to other vehicles that capture/store electrical energy with a battery, which may include electric-powered and gas-powered vehicles.

As discussed above, it would be desirable for a battery system 12 to be largely compatible with traditional vehicle designs. Accordingly, the battery system 12 may be placed in a location in the vehicle 10 that would have housed a traditional battery system. For example, as illustrated, the vehicle 10 may include the battery system 12 positioned similarly to a lead-acid battery of a typical combustion-engine vehicle (e.g., under the hood of the vehicle 10). Furthermore, as will be described in more detail below, the battery system 12 may be positioned to facilitate managing temperature of the battery system 12. For example, in some embodiments, positioning a battery system 12 under the hood of the vehicle 10 may enable an air duct to channel airflow over the battery system 12 and cool the battery system 12.

A more detailed view of the battery system 12 is described in FIG. 2. As depicted, the battery system 12 includes an energy storage component 14 coupled to an ignition system 16, an alternator 18, a vehicle console 20, and optionally to an electric motor 22. Generally, the energy storage component 14 may capture/store electrical energy generated in the vehicle 10 and output electrical energy to power electrical devices in the vehicle 10.

In other words, the battery system 12 may supply power to components of the vehicle's electrical system, which may include radiator cooling fans, climate control systems, electric power steering systems, active suspension systems, auto park systems, electric oil pumps, electric super/turbochargers, electric water pumps, heated windscreen/defrosters, window lift motors, vanity lights, tire pressure monitoring systems, sunroof motor controls, power seats, alarm systems, infotainment systems, navigation features, lane departure warning systems, electric parking brakes, external lights, or any combination thereof. Illustratively, in the depicted embodiment, the energy storage component 14 supplies power to the vehicle console 20, a display 21 within the vehicle, and the ignition system 16, which may be used to start (e.g., crank) an internal combustion engine 24.

Additionally, the energy storage component 14 may capture electrical energy generated by the alternator 18 and/or the electric motor 22. In some embodiments, the alternator 18 may generate electrical energy while the internal combustion engine 24 is running. More specifically, the alternator 18 may convert the mechanical energy produced by the rotation of the internal combustion engine 24 into electrical energy. Additionally or alternatively, when the vehicle 10 includes an electric motor 22, the electric motor 22 may generate electrical energy by converting mechanical energy produced by the movement of the vehicle 10 (e.g., rotation of the wheels) into electrical energy. Thus, in some embodiments, the energy storage component 14 may capture electrical energy generated by the alternator 18 and/or the electric motor 22 during regenerative braking. As such, the alternator 18 and/or the electric motor 22 are generally referred to herein as a regenerative braking system.

To facilitate capturing and supplying electric energy, the energy storage component 14 may be electrically coupled to the vehicle's electric system via a bus 26. For example, the bus 26 may enable the energy storage component 14 to receive electrical energy generated by the alternator 18 and/or the electric motor 22. Additionally, the bus 26 may enable the energy storage component 14 to output electrical energy to the ignition system 16 and/or the vehicle console 20. Accordingly, when a 12 volt battery system 12 is used, the bus 26 may carry electrical power typically between 8-18 volts.

Additionally, as depicted, the energy storage component 14 may include multiple battery modules. For example, in the depicted embodiment, the energy storage component 14 includes a lead acid (e.g., a first) battery module 28 in accordance with present embodiments, and a lithium ion (e.g., a second) battery module 30, where each battery module 70, 72 includes one or more battery cells. In other embodiments, the energy storage component 14 may include any number of battery modules. Additionally, although the first battery module 28 and the second battery module 30 are depicted adjacent to one another, they may be positioned in different areas around the vehicle. For example, the second battery module 30 may be positioned in or about the interior of the vehicle 10 while the first battery module 28 may be positioned under the hood of the vehicle 10.

In some embodiments, the energy storage component 14 may include multiple battery modules to utilize multiple different battery chemistries. For example, the first battery module 28 may utilize a lead-acid battery chemistry and the second battery module 30 may utilize a lithium ion battery chemistry. In such an embodiment, the performance of the battery system 12 may be improved since the lithium ion battery chemistry generally has a higher coulombic efficiency and/or a higher power charge acceptance rate (e.g., higher maximum charge current or charge voltage) than the lead-acid battery chemistry. As such, the capture, storage, and/or distribution efficiency of the battery system 12 may be improved.

To facilitate controlling the capturing and storing of electrical energy, the battery system 12 may additionally include a control module 32. More specifically, the control module 32 may control operations of components in the battery system 12, such as relays (e.g., switches) within energy storage component 14, the alternator 18, and/or the electric motor 22. For example, the control module 32 may regulate amount of electrical energy captured/supplied by each battery module 28 or 30 (e.g., to de-rate and re-rate the battery system 12), perform load balancing between the battery modules 28 and 30, determine a state of charge of each battery module 28 or 30, determine temperature of each battery module 28 or 30, determine a predicted temperature trajectory of either battery module 28 and 30, determine predicted life span of either battery module 28 or 30, determine fuel economy contribution by either battery module 28 or 30, determine an effective resistance of each battery module 28 or 30, control magnitude of voltage or current output by the alternator 18 and/or the electric motor 22, and the like.

Accordingly, the control module (e.g., unit) 32 may include one or more processors 34 and one or more memories 36. More specifically, the one or more processors 34 may include one or more application specific integrated circuits (ASICs), one or more field programmable gate arrays (FPGAs), one or more general purpose processors, or any combination thereof. Generally, the processor 34 may perform computer-readable instructions related to the processes described herein. Additionally, the processor 34 may be a fixed-point processor or a floating-point processor.

Additionally, the one or more memories 36 may include volatile memory, such as random access memory (RAM), and/or non-volatile memory, such as read-only memory (ROM), optical drives, hard disc drives, or solid-state drives. In some embodiments, the control module 32 may include portions of a vehicle control unit (VCU) and/or a separate battery control module. Additionally, as depicted, the control module 32 may be included separate from the energy storage component 14, such as a standalone module. In other embodiments, the battery management system (BMS) may be included within the energy storage component 14.

In certain embodiments, the control module 32 or the processor 34 may receive data from various sensors 38 disposed within and/or around the energy storage component 14. The sensors 38 may include a variety of sensors for measuring current, voltage, temperature, and the like regarding the battery module 28 or 30. After receiving data from the sensors 38, the processor 34 may convert raw data into estimations of parameters of the battery modules 28 and 30. As such, the processor 34 may render the raw data into data that may provide an operator of the vehicle 10 with valuable information pertaining to operations of the battery system 12, and the information pertaining to the operations of the battery system 12 may be displayed on the display 21. The display 21 may display various images generated by device 10, such as a GUI for an operating system or image data (including still images and video data). The display 21 may be any suitable type of display, such as a liquid crystal display (LCD), plasma display, or an organic light emitting diode (OLED) display, for example. Additionally, the display 21 may include a touch-sensitive element that may provide inputs to the adjust parameters of the control module 32 or data processed by the processor 34.

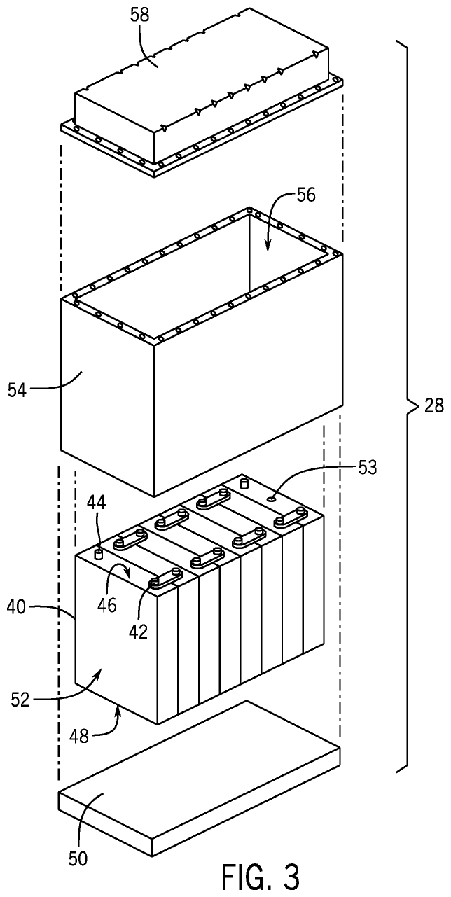

FIGS. 1 and 2 depict example systems that may house battery modules utilizing battery cells that are produced using the cell piercing methods described herein. FIG. 3 depicts an embodiment of the first (lithium ion) battery module 28 having battery cells 40 configured in accordance with the present disclosure. Further, while the lithium ion battery module 28 depicted in FIG. 3 includes many components that may be common to battery modules configured in accordance with the teachings herein, it should be noted that the illustrated module is provided as an example to facilitate discussion of certain aspects of the present disclosure, and is not intended to exclude the presence of other battery module features (e.g., a battery control module, service disconnects, terminals, and various thermal management features). Further, certain battery modules that utilize battery cells produced in accordance with the present disclosure may not include certain of the features described herein.

In the illustrated embodiment, the battery cells 40 each include a first terminal 42 and a second terminal 44 located at a terminal end 46 of the battery cell 40. The terminal end 46 may be considered to be positioned opposite a base end 48 of the battery cell 40, the base end 48 being the end of the battery cell 40 that is located proximate to a base 50 of the lithium ion battery module 28. The terminal end 46 may be part of a lid or cover assembly that encloses a casing 52 of the battery cell 40, and the casing 52 encloses the electrochemical elements of the battery cell 40 (e.g., the electrochemical cell and electrolyte). These electrochemical elements, during operation (and in particular during formation) of the battery cell 40, may generate gases. While illustrated as prismatic battery cells, it should be noted that the approaches described herein may also be applied to other battery cell geometries and types, for example cylindrical battery cells and pouch battery cells.

While illustrated as being located on the same end of the battery cells 40, in other embodiments, the first and second terminals 42, 44 may be located at different sides of the battery cell 40, such as one at the terminal end 46 and one at the base end 48. The terminal end 46, in accordance with certain embodiments of this disclosure, may include a cover that is pierceable, the cover being a part of the casing 52. The cover may include an opening 53, such as an electrolyte fill hole used for injection of electrolyte into the battery cell 40. As discussed in further detail herein, the opening 53 is sealed using a patch or other plug that may be subsequently pierced and re-sealed.

The illustrated lithium ion battery module 28 also includes a battery housing 54 (e.g., a lower housing), which couples to the base 50. While shown as separate components, in certain embodiments, the battery housing 54 and the base 50 may be integrally formed (e.g., molded, welded, fabricated) into a single piece into which the battery cells 40 are placed. The battery housing 54 and the base 50 may therefore define a cavity 56 for holding the battery cells 40. The battery housing 54, in general, protects the battery cells 40 from the external environment, and may maintain the position of each battery cell 40 relative to the other battery cells 40.

A module cover 58 is placed over the housing 54 to enclose the lithium ion battery module 28. In certain embodiments, the module cover 58 may house certain components, such as venting mechanisms for the battery module 28, electronics, and so forth. Further, in certain embodiments, the module cover 58 may be coupled to the housing 54 in a different orientation than the orientation illustrated in FIG. 3, depending on various design considerations (e.g., locations of module terminals, venting locations).

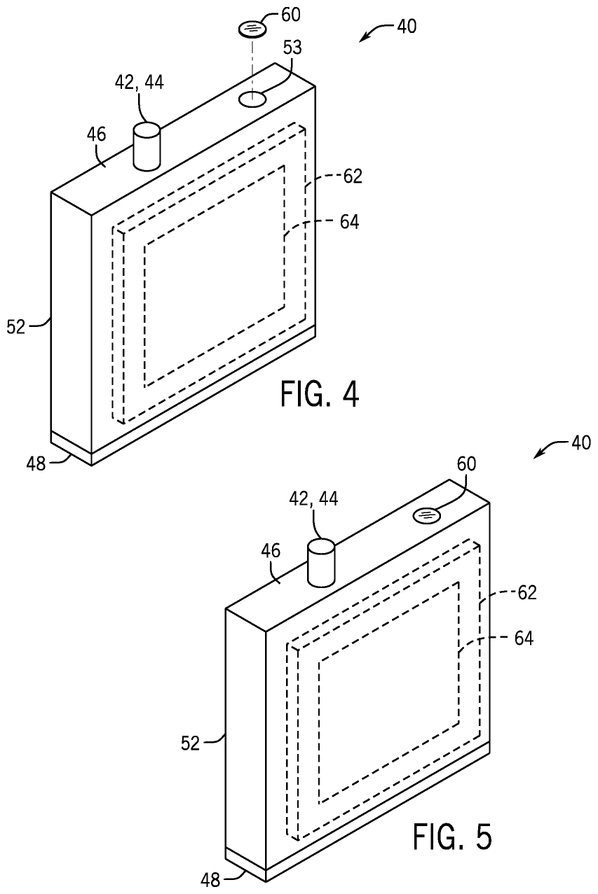

Returning now to the battery cell 40 and referring to FIG. 4, as set forth above, the battery cell 40 may include the opening 53, which is in fluid communication with an interior of the battery cell 40 and may be used initially for injection of electrolyte. The opening 53, while shown on the terminal end 46, may be on any surface of the casing 52, and may be formed during formation of the casing 52, or may be formed by punching or a similar operation post fabrication of the casing 52. Further, the terminals 42, 44 are shown schematically as a single post but it should be noted that the battery cell 40 may include multiple such posts disposed on the terminal end 46 and/or another end of the battery cell 40. After the electrolyte is injected, the opening 53 is sealed using a sealing patch 60 or other plug or seal by affixing the patch 60 or other plug or seal to the casing 52. By way of example, the sealing patch 60 may be laser welded, adhesively coupled or laminated (e.g., in the case of a pouch cell) to the surface of the casing 52 (in some embodiments, a lid surface). The battery cell 40 is then subjected to a formation process to condition an electrochemical cell 62 of the battery cell 40, the electrochemical cell 62 including active components 64. The active components 64 generally include an anode and a cathode that participate in electrochemical reactions to store and release energy.

During the formation process, the battery cell 40 may be subjected to one or more charge and discharge cycles, which may cause the electrochemical cell 62 to generate gases. It is presently recognized that such gases may be vented by piercing the sealing patch 60 in accordance with the techniques described herein.

Referring now to FIG. 5, in the illustrated embodiment, the patch 60 is welded or otherwise affixed to the battery casing 52 to seal the opening 53. In one embodiment, the patch 60 is pierceable and is an aluminum disk laser welded over the opening 53. However, in other embodiments, the patch 60 may be formed from another metal or may be non-metallic, for example, plastic or a polymer that is sealingly affixable over the opening 53. In one configuration, the patch 60 may have a thickness of between 0.1 mm to 0.3 mm and a diameter between 0.4 mm and 0.8 mm and be substantially rigid. Although shown as a disk, the patch 60 may be any shape or size and may seal the opening 53 by any form of affixation. The patch 60 may also be referred to herein as a “pierceable cover.”

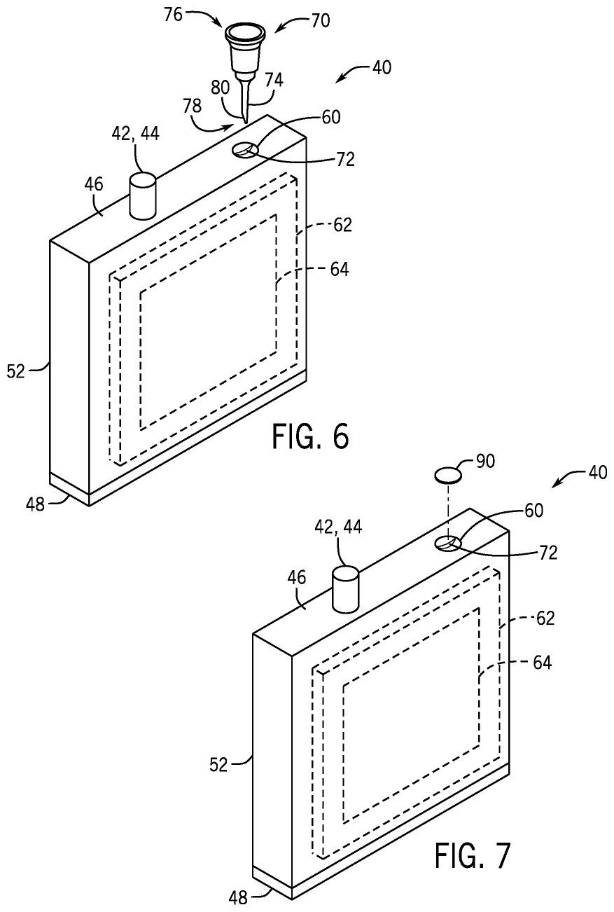

Referring now to FIG. 6, following the filling process and the opening 53 being sealed by the patch 60, a piercing tool 70 may be used to pierce through the patch 60 to create an aperture 72 in the patch 60 to release gas retained within the battery casing 52 to atmosphere. In an example configuration, the piercing tool 72 is an 18-gauge needle having an elongate shaft 74, being either hollow or solid, and having a proximal end 76 and a distal end 78, the distal end 78 being configured to pierce through the patch 60. In one configuration, the distal end 78 of the piercing tool 70 defines a beveled edge 80 configured to create a crescent shape for the aperture 72 through the patch 60.

In other embodiments, the distal end 78 may define any shape and diameter to create any shape for the aperture 72. In an example use of the piercing tool 70, the piercing tool 70 may punch through the patch 60 to either remove a portion of the patch 60 or to push back a portion of the patch 60 such that a portion of the patch 60 is pushed into the interior of the battery cell 40 (e.g., into the opening 53). The punch made by the piercing tool 70 may be made manually by an operator or automatically using a machine-driven punch. In one configuration, the piercing tool 70 creates the aperture 72 in the patch 60 while leaving a portion of the patch 60 attached such that the sealing element is not dislodged into the casing 52. Such a configuration avoids contamination of the electrolyte with the cover 60. In one configuration, the aperture 72 and the opening 53 may be coextensive following the piercing of the patch 60.

The piercing tool 70 as described herein is not limited to a needle. For instance, the particular device used as the piercing tool 70 may depend on the material construction of the casing 52, among other things (e.g., the internal pressure of the battery cell 40). By way of non-limiting example, the piercing tool 70 may be a transfer punch, a small hole punch, a push pin, or the like. Further, different gauges for the needle may be employed. While any of the above devices may be utilized, and while the list is not exhaustive, it has been found that these devices do not produce equivalent results. For example, it has been found that using a needle with a beveled edge as the piercing tool 70 produces the aperture 72 without producing particles of the casing material, which would otherwise contaminate the electrochemical cell 62. Indeed, the needle with the beveled leading edge, when used as the piercing tool 70, produces the aperture 60 as a relief cut into the patch 60. In one embodiment, the material for the casing is H14 aluminum, and in another embodiment, the material for the casing 52 is H19 aluminum. In such embodiments, it has been found that an 18-gauge needle produces superior results relative to a 20-gauge needle, and that both of these produce superior results relative to a transfer punch, a small hole punch, and a push pin, for producing the aperture 72 in a 0.0006″ thick 3003 AL (H14 and H19) aluminum disk that is laser welded to an aluminum battery cell casing. More specifically, it has been found that the needle having a beveled leading edge produces superior results relative to the other listed devices for producing the aperture 72 in a manner that avoids creating material that can fall into the electrochemical cell 62. Thus, it is recognized the piercing tool 70 may be arranged to either remove a portion of the patch 60 or to push back a portion of the patch 60 such that a portion of the patch 60 is left hanging.

Referring now to FIG. 7, an auxiliary patch 90 may be welded or otherwise affixed over the patch 60 to seal the aperture 72 following the release of gas from the casing 52. For example, the auxiliary patch 90 may be secured to the patch 60, or may be secured to the casing 52 in a region surrounding the patch 60 (or at least the aperture 72). Further, in embodiments where the battery cell 40 is a pouch cell, the process of affixing the auxiliary patch 90 to the battery cell packaging (housing) may include welding, laminating, adhesively securing, or the like, the auxiliary patch 90 to the battery cell packaging.

In certain embodiments, the auxiliary patch 90 is the same or substantially the same material as the patch 60 and may be affixed on top of the patch 60 in the same or similar manner as the patch 60 was originally affixed over the opening 53. For example, the auxiliary patch 90 may be a disk having the same or similar properties to that of the casing material 52.

In certain embodiments, the patch 60 may be non-metallic to avoid any metallic material from entering the battery housing 10, while the auxiliary patch 90 may be metallic. For example, the patch 60 may be smaller in diameter than the auxiliary patch 90. When the auxiliary patch 90 is sealed to the battery cell casing 52 following the piercing of the patch 60, the auxiliary patch 90 may be welded to the battery cell casing 52 around the patch 60 such that the auxiliary patch 90 is in direct contact with the battery cell casing 52.

By securing the auxiliary patch 90 over the patch 60, the resulting configuration may include an embodiment of the battery cell 40 in which the opening has a primary, ruptured patch and a secondary, intact patch. Thus, it should be appreciated that the structure of the battery cells 40 may have, in certain embodiments, distinct structural characteristics. For example, a cross-section of the battery cell 40 may show two patches disposed over the opening 53—a primary patch (the patch 60) that was pierced, and the auxiliary patch 90. Distinct markings from the separate operations of securing the patch 60 and the auxiliary patch 90 may also be present.

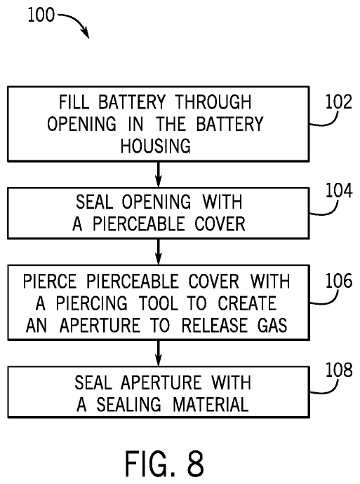

FIG. 8 is a process flow diagram depicting an embodiment of a method 100 of manufacturing a battery cell in accordance with the embodiments described herein. At operation 102, the method 100 includes filling the battery (battery cell) through the opening 53 in the battery housing (casing 53). For example, operation 102 may include a series of acts including filling the battery cell 40 with an electrolyte through the opening 53.

At operation 104, the method 100 includes sealing the opening 53 using, for example, the patch 60 as described with respect to FIGS. 4 and 5. For instance, the patch 60 may be positioned over the opening 53, and the patch 60 secured to the casing 52 (e.g., via laser welding). After sealing the battery cell 40 in this manner, it should be noted that the battery cell 40 may be subjected to a formation process in which the battery cell 40 is subjected to a predetermined charge and discharge cycle procedure. As set forth above, this generally results in an internal pressure increase in the battery cell 40.

At operation 106, the method 100 includes acts such as piercing the patch 60 (a pierceable cover 60) using the piercing tool 70 to create the aperture 72. By way of example, this may produce the configuration depicted in FIG. 6. As noted with respect to FIG. 6, piercing the patch 60 may allow the battery cell 40 to be degassed (e.g., placed under conditions where gases may escape from the interior of the battery cell 40). In accordance with certain embodiments, piercing the patch 60 using a needle with a beveled leading edge may form a relief cut in the patch 60, without producing particles or hanging material that would otherwise deleteriously affect operation of the battery cell 40.

At operation 108, the method 100 includes sealing the aperture 72 using the auxiliary patch 90 (a sealing element). For example, as discussed above with respect to FIG. 7, the auxiliary patch 90 may be secured over the patch 60, for example by securing the auxiliary patch 90 directly to the battery cell casing 52.

One or more of the disclosed embodiments, alone or on combination, may provide one or more technical effects including the manufacture of battery cells in a manner that allows the cells to be degassed and re-sealed. Manufacturing battery cells in this manner may avoid producing battery cells having a relatively elevated internal pressure before they are placed into operation, which may prolong their life and stabilize their operation. The technical effects and technical problems in the specification are exemplary and are not limiting. It should be noted that the embodiments described in the specification may have other technical effects and can solve other technical problems.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A method of manufacturing a battery cell, comprising:
introducing an electrolyte into a casing of the battery cell via an opening in the casing;
sealing the opening by securing a patch over the opening to seal the casing;
piercing the sealed opening to create an aperture through which gas escapes; and
sealing the aperture by securing an auxiliary patch over the aperture, wherein the patch, the auxiliary patch, or both, are made of aluminum.

2. (canceled)

3. The method of claim 1, wherein piercing the sealed opening comprises piercing the patch.

4. (canceled)

5. The method of claim 1, wherein securing the auxiliary patch over the aperture comprises securing the auxiliary patch over the entire patch.

6. The method of claim 5, wherein the battery cell casing is made of aluminum.

7. The method of claim 1, wherein securing the auxiliary patch over the aperture comprises welding the auxiliary patch onto the patch.

8. The method of claim 1, wherein securing the auxiliary patch over the aperture comprises welding the auxiliary patch onto the battery cell casing.

9. The method of claim 1, comprising subjecting the battery cell to a formation process such that an internal pressure of the battery cell increases, and wherein piercing the sealed opening to create the aperture through which gas escapes allows the increased internal pressure to be relieved.

10. The method of claim 1, wherein piercing the sealed opening to create the aperture includes piercing the sealed opening with a piercing tool.

11. The method of claim 8, wherein the piercing tool includes an elongate shaft having a proximal end and a distal end, and wherein the distal end defines a beveled edge such that the piercing step creates a relief cut in the sealed aperture.

12. The method of claim 9, wherein the elongate shaft is at least one from the group consisting of hollow and solid.

13. The method of claim 1, wherein the battery cell is a lithium-ion battery cell.

14. The method of claim 1, wherein the piercing the sealed opening to create the aperture through which gas escapes is completed in eight seconds or less.

15. A battery cell, comprising:
a battery cell casing enclosing an electrochemical cell and having an opening;
a patch secured over the opening in the battery cell casing and having a corresponding aperture; and
an auxiliary patch secured over the patch to seal the opening and the aperture in the patch, wherein the patch, the auxiliary patch, or both, are aluminum disks.

16. (canceled)

17. The battery cell of claim 15, wherein the aperture in the patch is a relief cut.

18. The battery cell of claim 15, wherein the auxiliary patch is directly secured to the patch.

19. The battery cell of claim 15, wherein the auxiliary patch is directly secured to the battery cell casing.

20. A lithium ion battery cell produced by a process comprising:
introducing an electrolyte into a casing of the battery cell via an opening in the casing;
sealing the opening by securing a patch over the opening to seal the casing;
piercing the sealed opening to create an aperture through which gas escapes; and
sealing the aperture by securing an auxiliary patch over the aperture, wherein the patch, the auxiliary patch, or both, are made of aluminum.
